(19) United States
(12) Patent Application Publication
(10) Pub. No.: US 2026/0344786 A1
(43) Pub. Date: Nov. 5, 2026

(54) AEROSOL PROVISION DEVICE COMPRISING AN ARTICLE SENSOR

(71) Applicant: NICOVENTURES TRADING LIMITED, London (GB)

(72) Inventor: Zhihuang XIAO, London (GB)

(21) Appl. No.: 19/721,685

(22) Filed: Jun. 26, 2026

Related U.S. Application Data
(63) Continuation of application No. 19/153,072, filed on Jan. 31, 2024.

(30) Foreign Application Priority Data
Feb. 1, 2023 (GB) 2301469.9

(51) Int. Cl. A24F 40/51; A24D 1/02; A24D 1/20; A24F 40/20; A24F 40/53

(52) U.S. Cl. CPC A24F 40/51; A24F 40/20; A24F 40/53; A24D 1/025; A24D 1/20

(57) ABSTRACT

An aerosol provision device configured to receive at least a portion of an article comprising aerosol generating material. The aerosol provision device comprises an article sensor and a processor. The article sensor comprises an infra-red (IR) transmitter configured to transmit a first IR signal to the article; and an IR receiver configured to receive a second IR signal from the article. The second IR signal is provided by reflection of the first IR signal from the article. The processor is configured to determine article information from a property of the second IR signal.

### PRIORITY CLAIM

The present application is a continuation of U.S. application Ser. No. 19/153,052 filed Aug. 1, 2025, which is a National Phase entry of PCT Application No. PCT/EP2024/052360 filed Jan. 31, 2024, which claims priority from United Kingdom Application no. 2301469.9 filed Feb. 1, 2023, each of which hereby fully incorporated herein by reference.

### TECHNICAL FIELD

The present invention relates to an aerosol provision device, an aerosol provision system and an article.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect, there is provided aerosol provision device configured to receive at least a portion of an article comprising aerosol generating material, the aerosol provision device comprising an article sensor and a processor, wherein the article sensor comprises: an infra-red (IR) transmitter configured to transmit a first IR signal to the article; and an IR receiver configured to receive a second IR signal from the article, wherein the second IR signal is provided by reflection of the first IR signal from the article, wherein the processor is configured to determine article information from a property of the second IR signal.

The property of the second IR signal may be dependent on a colour of a portion the article.

The property of the second IR signal may be dependent on a texture of a portion of the article.

The property of the second IR signal may be dependent on a material of a portion of the article.

The property of the IR signal may be a signal strength of the second IR signal. The property of the IR signal may be a frequency of the second IR signal. The property of the IR signal may be a wavelength of the second IR signal.

The article information comprises a presence of the article.

The article information may comprise a type of the article.

The article information may comprise an authentication status of the article.

The processor may be configured to select a heating session in response to the article information.

The processor may be configured to determine whether the second IR signal has a receiver signal strength below a detection threshold; and in response to the signal strength being below the detection threshold, modify an operation parameter of the article sensor to increase the signal strength.

The operation parameter may be a transmitter signal strength of the first IR signal.

The aerosol provision device may comprise a light guide, the light guide configured to receive the second IR signal from the article and transmit the second IR signal to the IR receiver.

The light guide may extend between the article and the IR receiver.

The light guide may change the direction of the IR signal.

The light guide may transmit the IR signal in a longitudinal direction of the device.

The light guide may transmit the IR signal along a path between the article and the IR receiver.

The path may be determined by the geometry of the light guide.

The IR receiver may be arranged to be orientated perpendicular to the lightguide.

The IR receiver may be arranged to be orientated on along the same axis as the lightguide.

The length of the light guide may be between 1 mm and 50 mm. The light guide may be approximately 1 mm to 12 mm in length.

The light guide 130 may have a length of at least 1 mm, at least 10 mm, at least 20 mm, at least 30 mm, or at least 40 mm.

The light guide may have a length of less than 10 mm, less than 12 mm, less than 20 mm, less than 30 mm, less than 40 or less than 50 mm.

The light guide may have a transparency of more than 32%. The light guide may have a transparency of 10% or more, 20% or more, 25% or more, 30% or more, 40% or more.

The light guide may have a transparency of more than 35%, more than 37%, more than 53%, more than 66%, more than 82%, or more than 91%.

The light guide may have a transparency of less than 32%.

The aerosol provision device may further comprise a second light guide configured to direct the IR signal from the IR transmitter to the article.

According to a second aspect, there is provided an article comprising aerosol generating material, the article further comprising an indicator portion, the indicator portion configured to reflect the first IR signal to provide the second IR signal to an aerosol provision device to indicate article information.

The indicator portion may be textured, a texture of the indicator portion indicating article information.

The indicator portion may be coloured, a colour of the indicator portion indicating article information.

The indicator portion may be formed of a material, the material indicating article information.

According to a third aspect, there is provided an aerosol provision system comprising an aerosol provision device described above and an article described above. The aerosol provision system may comprise any of the features of the aerosol provision device or the article described above.

According to a fourth aspect, there is provided a method of determining article information of an article, the method comprising: transmitting a first IR signal to the article; receiving a second IR signal from the article, the second IR signal being provided by reflection of the first IR signal from the article; and determining the article information from a property of the second IR signal. The method may comprise any of the features or functional steps described with respect to the first, second and/or third aspects.

According to a fifth aspect, there is provided an article comprising an aerosol generating material, the article comprising an indicator portion, wherein the indicator portion comprises a magnetic material, wherein the indicator portion is indicative of article information.

The indicator portion may comprise a printed ink comprising the magnetic material.

The indicator portion may be a band surrounding or substantially surrounding the article. For example, the band may surround at least 90% of the article. For example, the band may surround at least 95% of the article.

The article may be substantially cylindrical, the band encircling the article.

The article may comprise an outer surface, the outer surface formed of paper, wherein the magnetic material is provided on the outer surface

The article information may comprise a type of the article.

The article information may comprise an authentication status of the article.

According to a sixth aspect, there is provided an aerosol provision device, the aerosol provision device configured to receive at least a portion of the article to form an aerosol from the aerosol generating material, the aerosol provision device comprising an article sensor and a processor, wherein the article sensor comprises a hall effect sensor configured to receive a signal from the indicator portion, the processor configured to determine article information from the signal.

The processor may be configured to select a heating session in response to the article information.

The processor may be configured to determine whether the signal has a receiver signal strength below a detection threshold; and in response to the signal strength being below the detection threshold, modify an operation parameter of the article sensor to increase the signal strength. The operation parameter may be a current supplied to the hall effect sensor. The current may be increased to increase the signal strength.

According to a seventh aspect, there is provided an aerosol provision system comprising an aerosol provision device described above and an article described above.

According to an eighth aspect, there is provided a method of determining article information comprising receiving at a hall effect sensor a signal from an indicator portion of an article and determining article information from the signal. The method may comprise any of the features or functional steps described with respect to the fifth, sixth and/or seventh aspects.

### BRIEF DESCRIPTION OF THE DRAWINGS

Embodiments will now be described, by way of example only, and with reference to the accompanying drawings in which:

FIG. 1 shows a side view of an aerosol provision system;

FIG. 2 shows a perspective view of an article;

FIG. 3 shows a cross-sectional side view of an aerosol provision system;

FIG. 4 shows a schematic drawing of an aerosol provision system; and

FIG. 5 shows a schematic drawing of an aerosol provision device comprising a light guide.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

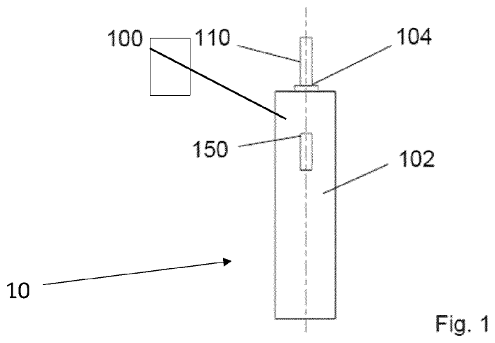

With reference to FIG. 1, an aerosol provision system 10 comprises an aerosol provision device 100 for generating aerosol from an aerosol generating material. The aerosol provision system 10 further comprises a replaceable article 110 comprising the aerosol generating material. In broad outline, the aerosol forming device 100 may be used to heat the article 110 to generate an aerosol or other inhalable medium, which is inhaled by a user of the device 100.

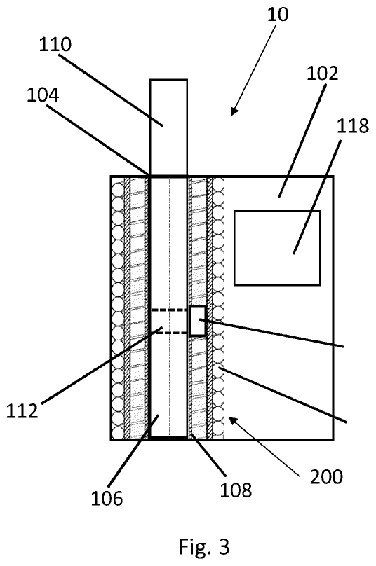

The aerosol forming device 100 comprises a body 102. A housing arrangement surrounds and houses various components of the body 102. An article aperture 104 is formed at one end of the body 102, through which the article 110 may be inserted for heating by an aerosol generator 200, which is described below with respect to FIG. 3.

The device 100 may also include a user-operable control element 150, such as a button or switch, which operates the device 100 when pressed. For example, a user may turn on the device 100 by operating the switch 150.

The aerosol generator 200 defines a longitudinal axis, which aligns with an axis of the article 110.

In use, the article 110 may be fully or partially inserted into the aerosol generator 200 where it may be heated by one or more components of the aerosol generator 200.

The device 100 includes an apparatus for heating aerosol-generating material. The apparatus includes an aerosol generating assembly, a controller (control circuit), and a power source. The apparatus forms part of the body 102. The aerosol generating assembly is configured to heat the aerosol-generating material of an article 110 inserted through the article aperture 104, such that an aerosol is generated from the aerosol generating material. The power source supplies electrical power to the aerosol generating assembly, and the aerosol generating assembly converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source may be electrically coupled to the aerosol generating assembly to supply electrical power when required and under control of the controller to heat the aerosol generating material. The control circuit may be configured to activate and deactivate the aerosol generating assembly based on a user input. The user input may be via a button press or opening a door of the device (for example, a door covering a consumable receiving receptacle). The control circuit may be configured to activate and deactivate automatically, for example on insertion of an article.

The aerosol generating assembly may comprise various components to heat the aerosol generating material via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

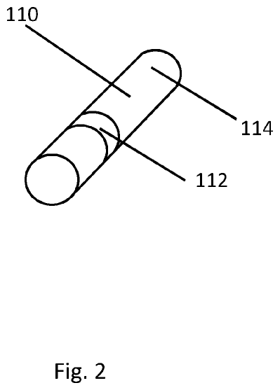

With reference to FIG. 2, the article 110 comprises an indicator portion 112. The indicator portion 112 is indicative of article information. The article information comprises a type of the article 110, for example, a flavour, a strength and/or a size of the article 110. The article 110 comprises the aerosol generating material (not shown in FIG. 2). In examples, the indicator potion 112 may be located on any part of the article 110 that is inside the device 100 in use. For example, the indicator portion 112 may be located ay any part along the length of the article 110. In examples, the indicator portion 112 may, in use, be located proximate the opening 109 of the device 100.

The indicator portion 112 is on an outer surface 114 of the article 110. The outer surface 114 may be formed from paper, with the indicator portion 112 printed on the paper. The indicator portion 112 is a band which surrounds the article 110. The indicator portion 112 encircles the article 110. As described in more detail below, the indicator portion 112 may be a magnetic material or a portion to reflect an infra-red (IR) signal.

With reference to FIG. 3, a portion of the article 110 is received in a receptacle 106 of the aerosol provision device 100. The receptacle 106 is a cylindrical chamber, extending from the article aperture 104 into the body 102. The article 110 is inserted through the aperture 104 into the receptacle 106, such that the identifier 112 is positioned within the receptacle 106. The receptacle 106 is defined by a wall 108.

The aerosol provision device 100 comprises an aerosol generator 200. The aerosol generator 200 is a heating assembly. The aerosol generator 200 comprises an inductive element 202. The inductive element 202 is an inductive coil surrounding the receptacle 106. The aerosol generator 200 comprises a susceptor element 108, which, in the present embodiment, is the wall 108.

The aerosol provision device 100 comprises an article sensor 116. The receptacle 108 comprises an opening 109. The article sensor 116 is positioned at the opening 109. The article sensor 116 is positioned outside the receptacle 108 beyond the opening 109, such that the article sensor 116 is in optical communication with the receptacle through the opening 109. In some embodiments, the wall 108 comprises a translucent portion, with the article sensor 116 located outside the wall 108 beyond the translucent portion.

The article sensor 116 is positioned such that when the article 110 is received in the receptacle 106, the indicator portion 112 is aligned with the article sensor 116. The indicator potion 112 may be located on any part of the article 110 that, in use, is suitable located inside the device 100.

The aerosol provision device 100 comprises a processor 118 in data communication with the article sensor 116.

In use, a user inserts the article 110 into the aerosol provision device 100. The user activates the user operable control element 150, which causes the aerosol provision device to perform an article identification process. In the article identification process, the article sensor receives a receiver signal from the indicator portion. The processor determines article information from the receiver signal. The article information comprises a type of the article. In some examples, the article information comprises a presence of the article in the device or an authentication status of the article.

The processor performs a signal strength adjustment process, in which the processor determines whether the receiver signal has a receiver signal strength below a detection threshold. To determine that the receiver signal strength is below the detection threshold, the processor may determine a signal to noise ratio of the light signal, with a signal to noise ratio below a SNR threshold indicating that the receiver signal strength is below the detection threshold. To determine that the receiver signal strength is below the detection threshold, the processor may try to perform the article information, and, in the event that the processor cannot determine article information, determine that the receiver signal strength is below the detection threshold. In response to the receiver signal being determined to be below the detection threshold, the processor modifies an operation parameter of the article sensor to increase the receiver signal strength.

The aerosol generator 200 generates an aerosol from the article 110. The aerosol provision device 100 supplies an alternating current to the inductor element 202, which causes the susceptor element 108 to heat the aerosol generating material of the article 110.

The susceptor element 108 heats the aerosol generating material by applying a heating profile, with an operating temperature, over an aerosol generating session. The heating profile is dependent on the article information, with different heating profiles being applied for different types of article. The operating temperature is dependent on article information, with the aerosol generating material being heated to different operating temperatures in different types of article. The session length (i.e. a time period during which the aerosol generator generates from the aerosol generating material) of the aerosol generating session is dependent on article information, with different session lengths being used for different types of article.

At the end of the aerosol generating session, the aerosol generator 200 stops generating aerosol from the aerosol generating material. The user removes the article 110 from the aerosol provision device 100 and disposes of the article 110.

In some examples, the article sensor 116 is a hall effect sensor. The indicator portion 112 comprises a magnetic material. The indicator portion 112 may comprise a printed ink comprising the magnetic material. The printed ink may be printed to the outer surface of the article 110.

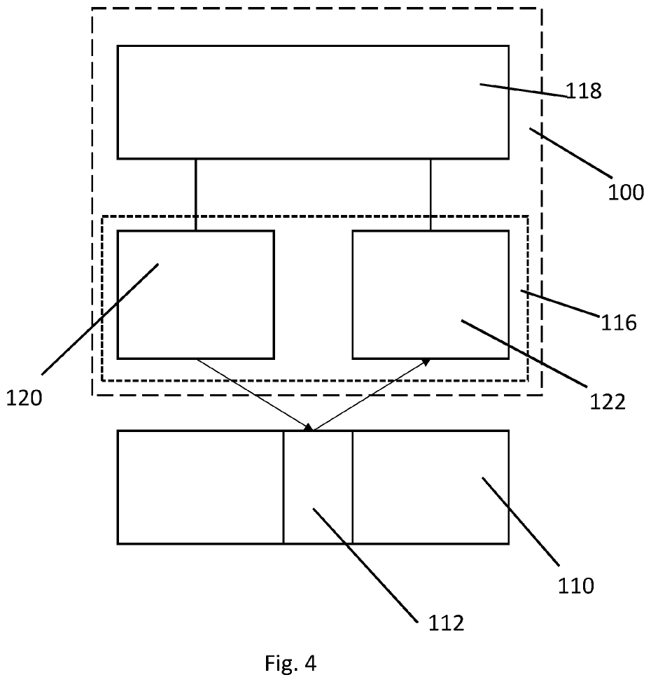

When the article sensor 116 is a hall effect sensor, in the signal strength adjustment process, the processor increases a current supplied to the hall effect sensor to modify the operation parameter of the article sensor to increase the receiver signal strength. In examples, the voltage supplied to the hall effect sensor may be increased. The sensitivity and/or the resolution of the hall effect sensor may be increased. The mass and/or thickness of the magnetic material may vary between types of articles to indicate the type of article. In other examples, (as illustrated in more detail FIG. 4) the article sensor 116 is an infra-red (IR) sensor. The article sensor 116 comprises a transmitter 120 and a receiver 122. The transmitter 120 is in optical communication with the article 110. The receiver 122 is in optical communication with the article 110. The transmitter is in optical communication with the indicator portion 112. The receiver 122 is in optical communication with the indicator portion 112.

The transmitter 120 is configured to transmit a transmitter signal to the article 110. The transmitter 120 is an IR source configured to transmit IR radiation to the article 110. The transmitter signal is a first IR signal.

The receiver 122 is configured to receive a receiver signal from the article 110. The transmitter signal causes the receiver signal to reach the receiver 122. The transmitter signal is reflected from the article 110, more specifically, from the indicator portion 112. The receiver 122 is an IR receiver configured to receive IR reflected from the article 110. The IR reflected from the article is a second IR signal. The processor 118 is configured to determine article information from a property of the second IR signal. The property of the second IR signal is the frequency of the second IR signal.

In examples, the property of the second IR signal may be the wavelength, frequency or the switch pulse.

In examples, the indicator portion 112 may be a textured portion of the article 110. The texture of the textured portion affects how the first IR signal is reflected to provide the second IR signal, such that the property of the second IR signal (in this example the frequency) depends on the texture of the textured portion. The texture of the textured portion may correspond to the article information, for example, varying according to the type of the article.

In examples, the textured portion of the article may be formed from paper or similar-type material. The texture may be determined during manufacture. For example, the texture may be determined during pressing, rolling or drying of a paper material. In examples, the textured portion may be in the form of a dot or wrinkle pattern in the article.

In other examples, the colour of the indicator portion may affect the property of the second IR signal. The colour of the indicator portion may correspond to the article information, for example, varying according to the type of the article. In examples, the indicator portion may comprise more than one colour. The indicator portion may comprise black and white portions. In examples, the indicator portion may comprise red, green and/or blue portions.

In other examples, the material of the indicator portion may affect the property of the second IR signal. The material of the indicator portion may correspond to the article information, for example, varying according to the type of the article.

In examples, a surface matrix in the indicator portion may affect the property of the second IR signal. The surface matrix in the indicator portion may correspond to the article information. The surface matrix may comprise a textured and/or coloured portions. When the article sensor 116 is the IR sensor, in the signal strength adjustment process, the processor increases the current to the transmitter 120 to modify the operation parameter of the article sensor to increase the signal strength. In examples, the voltage supply to the IR transmitter may be increased.

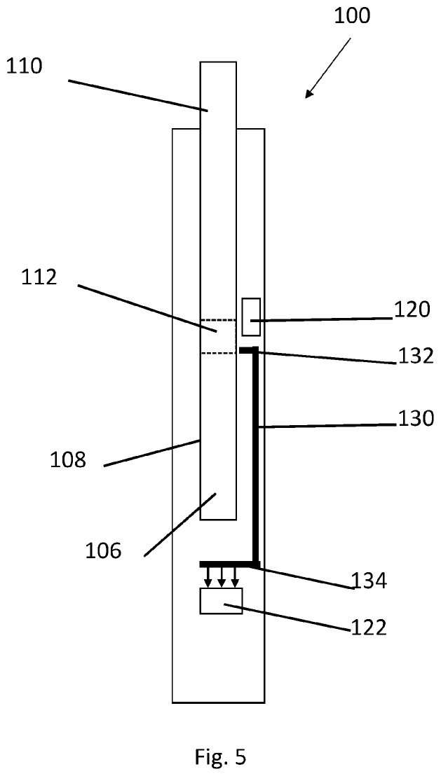

Referring to FIG. 5, there is shown a schematic drawing of an aerosol provision device 100 and article 110 substantially described as above and further comprising a lightguide 130. The IR transmitter 120 adjacent to indicator portion 112 on the article 110. The IR receiver 122 is spaced away from the receptacle 106.

The light guide 130 has a first end 132 which is positioned adjacent to the wall 108. A second end 134 of the light guide 130 is adjacent to the IR receiver 120. The light guide 130 extends longitudinally along the device, from the article 110 to the IR receiver 122. The light guide defines a path between the article 110 and the IR receiver 122.

The light guide 130 may have a length of at least 1 mm, at least 10 mm, at least 20 mm, at least 30 mm, or at least 40 mm.

In examples, the light guide may have a length of less than 10 mm, less than 12 mm, less than 20 mm, less than 30 mm, less than 40 or less than 50 mm.

In examples, the light guide may have a length of more than 50 mm.

The light guide may have a transparency of 32% or more. In embodiments, the light guide may have a transparency of more than 35%, more than 37%, more than 53%, more than 66%, more than 82%, or more than 91%.

In examples, the light guide may have a transparency of less than 32%.

In examples, the light guide may have a transparency of 10% or more, 20% or more, 25% or more, 30% or more, 40% or more.

In use, the transmitter 120 initially transmits the first IR transmitter signal to the article 110. The transmitter signal is reflected from the article 110, more specifically, from the indicator portion 112. The IR reflected from the article is a second IR signal.

The second IR signal is received at the first end 132 of the light guide 130. The second IR signal is transmitted through the light guide 130 from its first end 132 to its second end 134.

The second IR signal exits the light guide 130 at the second end 134. The second end 134 of the light guide is orientated parallel to the IR receiver 122. The second IR signal is received by the IR receiver 122. The light guide 130 concentrates the second IR signal to provide an amplified signal to the IR receiver 122. The processor 118 is configured to determine article information from a property of the second IR signal.

In embodiments, the IR receiver is orientated along the same axis as the light guide. The IR receiver being orientated along the same axis may mean that the IR receiver is configured to receive a signal travelling along the axis, parallel to the axis or with a component parallel to the axis. In embodiments, the IR receiver is orientated perpendicular to the light guide. The IR receiver being orientated perpendicular to the light guide may mean that the IR receiver is configured to receive a signal that exits the light guide perpendicular to the path on which it has been transmitted.

In embodiments, the path defined by the light guide 130 may differ. For example, the path may not have a bend at the second end 132. The light guide may wrap around the receptacle 106.

In embodiments, the second end of the light guide may be arranged at the mouth end of the device. The aerosol provision device may be provided as a two part device comprising first and second boundaries that are separable at a boundary between the first and second portions. The article is insertable into a receptacle that extends across the boundary and into the first and second portions. The indicator portion is arranged to be received in the first portion. The IR transmitter is arranged in the first portion of the aerosol provision device. The IR receiver is arranged in the second portion of the aerosol provision device. The reflected signal passes across the boundary between the first and second portions of the aerosol provision device before being received by the IR receiver. The light guide is configured to extend across the boundary between the first and second portions of the aerosol provision device to direct the signal to the IR receiver.

In embodiments, the light guide is ring shaped to receive a signal from the article around an inner surface of the light guide. The light guide is then configured to transmit the signal to the IR receiver.

In embodiments, a further light guide may be provided. The further light guide may extend from the IR transmitter to the article, more specifically, to the indicator portion. In use, the further light guide transmits the first IR signal from the IR transmitter to the indicator portion of the article.

In the above described embodiments, the aerosol provision device comprises a heating arrangement that is an inductive heating arrangement. In embodiments, other types of heating arrangement are used, such as resistive heating. The configuration of the device is generally as described above and so a detailed description will be omitted. In such arrangements the aerosol generating assembly comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system comprising an aerosol provision device and an article, the article comprising aerosol generating material, the aerosol provision system comprising an aerosol generator for heating the article, the article comprising:
an outer surface formed from paper; and
an indicator portion, the indicator portion being formed from paper,
wherein the aerosol provision device comprises an article sensor configured to a receive a receiver signal from the indicator portion,
wherein the aerosol provision device comprises a processor configured to determine article information from the receiver signal,
wherein the article information comprises a type of the article and an authentication status of the article,
wherein the indicator portion indicates the type of the article based on the texture of the indicator portion,
wherein the aerosol provision device is configured to apply different heating profiles for different types of article.

2. An aerosol provision system according to claim 1, wherein the indicator portion comprises a dot pattern.

3. An aerosol provision system according to claim 1, wherein the indicator portion comprises a wrinkle pattern.

4. An aerosol provision system according to claim 1, wherein the indicator portion comprises a band.

5. An aerosol provision system according to claim 4, wherein the band substantially surrounds the article.

6. An aerosol provision system according to claim 5, wherein the band encircles the article.

7. An aerosol provision system according to claim 1, wherein the article is substantially cylindrical.

8. An aerosol provision system according to claim 1, wherein the article sensor comprises: an infra-red (IR) transmitter configured to transmit a first IR signal to the article; and an IR receiver configured to receive a second IR signal from the article, wherein the second IR signal is provided by reflection of the first IR signal from the article, wherein the processor is configured to determine article information from a property of the second IR signal,
wherein the second IR signal is the receiver signal,
wherein the property of the second IR signal is dependent on the texture of the indicator portion.

9. An aerosol provision system according to claim 8, wherein the property of the IR signal is a signal strength of the second IR signal.

10. An aerosol provision system according to claim 8, wherein the property of the IR signal is a frequency of the second IR signal.

11. An aerosol provision system according to claim 8, wherein the property of the IR signal is a wavelength of the second IR signal.

12. An aerosol provision system according to claim 1, wherein the article information comprises a presence of the article.

13. An aerosol provision system according to claim 1, wherein the processor is configured to:
determine whether the receiver signal has a receiver signal strength below a detection threshold; and
in response to the signal strength being below the detection threshold, modify an operation parameter of the article sensor to increase the receiver signal strength.
